(19) United States
(12) Patent Application Publication
(10) Pub. No.: US 2015/0158325 A1
(43) Pub. Date: Jun. 11, 2015

(54) SPECIAL-EFFECTS SURFACES

(71) Applicant: CRAYOLA, LLC, Easton, PA (US)

(72) Inventors: LUIS RODRIGO PINEIRO, BETHLEHEM, PA (US); CRAIG SKINNER, EASTON, PA (US)

(21) Appl. No.: 14/565,573

(22) Filed: Dec. 10, 2014

Related U.S. Application Data
(60) Provisional application No. 61/914,064, filed on Dec. 10, 2013.

(51) Int. Cl. B43L 1/00

(52) U.S. Cl. CPC B43L 1/00

(57) ABSTRACT

A special-effects treatment is provided that is applied to a substrate to create a special-effects surface. In embodiments, the special-effects surface includes a washable chalkboard treatment applied to a substrate to provide a washable chalkboard surface. A chalk marking on the washable chalkboard surface may be removed using water. In a further embodiment, the special-effects treatment includes a high-intensity treatment applied to a substrate to provide a high-intensity surface. The high-intensity surface maintains a marking in close proximity to the surface to provide a brighter and/or bolder appearance compared to a marking on a non-treated surface.

### CROSS-REFERENCE TO RELATED APPLICATIONS

This application claims priority to U.S. Provisional Patent Application No. 61/914,064, entitled “Special-Effects Substrates,” filed Dec. 10, 2013, having Attorney Docket No. HALC.197370, the entirety of which is hereby incorporated by reference.

### SUMMARY

Embodiments of the invention are defined by the claims below, not this summary. A high-level overview of various aspects of the invention are provided here for that reason, to provide an overview of the disclosure, and to introduce a selection of concepts that are further described in the detailed description section below. This summary is not intended to identify key features or essential features of the claimed subject matter, nor is it intended to be used as an aid in isolation to determine the scope of the claimed subject matter.

In brief and at a high level, this disclosure describes, among other things, a special-effects surface for receiving markings. In general, the invention is directed to special-effects treatments for application to a substrate that, when the treatment is applied to the substrate, create special-effects surfaces configured to accept markings from a marking device and provide a corresponding visual effect. In one embodiment, a kit is provided that contains one or more special-effects treatments and one or more marking devices, the marking devices being configured to interact with the special-effects treatments. The special-effects treatments are formulated to be applied to a substrate, such as a poster board, paper, foam core board, a wall, paint, wood, plastic, concrete, glass, cloth, porous, nonporous, or other suitable substrate. The special-effects treatments may be available in any number of application forms configured to coat at least a portion of the surface of a substrate. In some embodiments, the special-effects treatment may include a solution configured to coat the surface of the substrate; a powder configured to coat the surface of the substrate; a gel formulation configured to coat the surface of the substrate; a sheet containing a quantity of a special-effects treatment configured to cover the surface of the substrate; an adhesive-backed sheet containing a quantity of the special-effects treatment configured to cover the surface of the substrate; and an aerosol application configured to coat the surface of the substrate.

In one embodiment, the special-effects treatment includes a washable chalkboard treatment applied to a substrate to provide a washable chalkboard surface. Upon applying a chalk marking to the washable chalkboard surface, the chalk marking may be removed from the surface using water, a cleaning solution, a cleaning foam, a cloth, a chalk eraser, a paper towel, or any other means adapted to remove markings from a washable chalkboard surface. In some aspects, the chalk marking on the treated washable chalkboard surface may have different characteristics based on the interaction between the chalk marking and the washable chalkboard treatment. For example, in one embodiment, a surface that was unable to receive chalk markings (e.g., a glossy and/or smooth non-chalkboard surface) may be able to accept chalk markings (and retain and/or exhibit the chalk markings applied to its surface) after being treated with the washable chalkboard treatment.

In a further embodiment, the special-effects treatment includes a high-intensity treatment applied to a substrate to provide a high-intensity surface. Upon applying a marking to the high-intensity surface, the high-intensity treatment maintains the marking in close proximity to the surface to provide a brighter and/or bolder appearance compared to a marking on a non-high-intensity treated surface. In further aspects, a marking applied to a substrate treated with the high-intensity treatment may become a permanent marking, thereby no longer being removable from the treated surface. In another embodiment, a washable marking device may be applied to a high-intensity surface (i.e., a substrate treated with a high-intensity treatment) and may produce a marking that is not washable based on an interaction between the marking from the washable marking device and one or more characteristics of the high-intensity surface.

### DESCRIPTION OF THE DRAWINGS

Illustrative embodiments of the invention are described in detail below with reference to the attached drawing figures, and wherein:

FIG. 1 is a flow diagram showing a method of making a washable chalkboard surface, in accordance with an embodiment of the invention;

FIG. 2 is a flow diagram showing a method of making a high-intensity surface, in accordance with an embodiment of the invention;

FIG. 3 is a front view of a user removing a marking from a washable chalkboard surface, in accordance with an embodiment of the invention; and

FIG. 4 is a front view of a marking on a non-high-intensity surface and a high-intensity surface, in accordance with an embodiment of the invention.

### DETAILED DESCRIPTION

The subject matter of select embodiments of the invention is described with specificity herein to meet statutory requirements. But the description itself is not intended to necessarily limit the scope of the claims. Rather, the claimed subject matter might be embodied in other ways to include different components, steps, or combinations thereof similar to the ones described in this document, in conjunction with other present or future technologies. Terms should not be interpreted as implying any particular order among or between various steps herein disclosed unless and except when the order of individual steps is explicitly described.

Embodiments of the invention are directed to the creation of special-effects surfaces for receiving markings from traditional marking devices, such as markers, washable markers, chalk, paint, and the like. The special-effects surfaces are created by applying a special-effects treatment to a substrate that coats the substrate with the special-effects treatment and creates a special-effects surface. Substrates may include poster board, paper, foam core board, a wall, paint, wood, plastic, concrete, glass, cloth, porous, nonporous, or other suitable substrate. In embodiments, the application of the special-effects treatment to the substrate creates a special-effects surface capable of receiving markings. For example, the application of a special-effects treatment to a substrate may create a high-intensity surface for receiving one or more different types of markings.

Using a variety of marking devices, the resulting images created on the special-effects surfaces may provide various visual effects. In some embodiments, a visual effect may include displaying a marking with enhanced intensity as compared to marking on an untreated surface; displaying a marking of a different color on the treated surface that would not be displayed on an untreated surface; displaying colored markings upon application of water; displaying a marking with a neon effect on the treated surface upon the application of a mark from a marking device, wherein the marking would be without a neon effect when applied to an untreated surface; and displaying a plurality of colors on the treated surface regardless of the color that a marking device would display on an untreated surface, among others. As such, the special-effects surface may receive and/or exhibit markings with a particular effect that was not possible on an un-treated surface. In embodiments, using traditional marking devices, the resulting images may be easily removed from some of the special-effects surfaces, such as by removal using water, a cleaning solution, cleaning foam, a cloth, a chalk eraser, a paper towel, a cloth adapted to facilitate removal of markings, or any other means adapted to remove markings from a surface. In further embodiments, the marking on a special-effects surface with a non-permanent marking device may become permanent based on the special-effects treatment.

In one embodiment, a kit is provided that contains one or more special-effects treatments and one or more marking devices, the marking devices being configured to interact with the special-effects treatments. For example, a kit with a washable chalkboard treatment may have a corresponding chalk marking device configured to interact with the washable chalkboard treatment also contained within the kit. Additionally, a high-intensity treatment contained within the kit may have a corresponding marking device configured to interact with the high-intensity treatment also contained within the kit. Embodiments of the special-effects treatments are formulated to be applied to a substrate, such as a poster board, paper, foam core board, a wall, paint, wood, plastic, concrete, glass, cloth, porous, nonporous, or other substrate. The special-effects treatments may be available in any number of forms and configured to coat the surface of the substrate. Embodiments of such treatments may be available in forms including, but not limited to: a solution configured to coat the surface of the substrate; a powder configured to coat the surface of the substrate; a gel formulation configured to coat the surface of the substrate; a sheet containing at least a quantity of a special-effects treatment configured to cover the surface of the substrate; an adhesive-backed sheet containing at least a quantity of a special-effects treatment configured to cover the surface of the substrate; and an aerosol application configured to coat the surface of the substrate. In some aspects, a special-effects treatment, such as a high-intensity treatment, may be applied to a number of different types of substrates having a variety of different shapes and/or textures.

In some embodiments, the kit may include a removal device and/or an agent adapted to aid in the removal of markings. For example, the removal devices and/or agents may include: a cleaning solution; a cleaning foam; an eraser; a cloth adapted to facilitate removal of markings; or any other device and/or agent adapted to remove markings from the special-effects surface.

In another embodiment, the special-effects surface includes a washable chalkboard treatment applied to a substrate, such as a poster board, paper, foam core board, a wall, paint, wood, plastic, concrete, glass, cloth, porous, nonporous, or other substrate, to create a washable chalkboard surface. Chalk markings applied to the washable chalkboard surface may be subsequently removed from the surface. For example, a washable chalkboard treatment may be applied to a paper substrate to generate a washable chalkboard surface for receiving chalk markings from a chalk device. In some embodiments, the chalk device may deposit chalk residue on the washable chalkboard surface that may be removed from the washable chalkboard surface using water, a cleaning solution, a cleaning foam, a cloth, a chalk eraser, a paper towel, a cloth adapted to facilitate removal of markings, or any other means adapted to remove markings from a surface.

In embodiments, the washable chalkboard treatment includes: a solution configured to coat the surface of the substrate; a powder configured to coat the surface of the substrate; a gel formulation configured to coat the surface of the substrate; a sheet containing a quantity of a washable chalkboard treatment configured to cover the surface of the substrate; an adhesive-backed sheet containing a quantity of a washable chalkboard treatment configured to cover the surface of the substrate; and an aerosol application configured to coat the surface of the substrate, and the like. As a result, the washable chalkboard treatment may come in a variety of forms for application to a plurality of substrates. In some aspects, a substrate for receiving a washable chalkboard treatment may be any shape and/or have a variety of different types of textures on its surface.

Upon applying the washable chalkboard treatment to a substrate, a washable chalkboard surface is created. Additionally, the washable chalkboard treatment may be available in forms such that the appearance of the washable chalkboard surface will vary. In embodiments, these appearances may include a clear washable chalkboard surface, a semi-opaque washable chalkboard surface, and an opaque washable chalkboard surface. In one aspect of the invention, the semi-opaque and/or opaque washable chalkboard surfaces may generate a plurality of colored or semi-colored surfaces. For example, the opaque washable chalkboard surface may have a black appearance or a green appearance, similar to a traditional chalkboard. The opaque washable chalkboard surface may also have an appearance of a plurality of other colors, according to some embodiments. By way of further example, a clear washable chalkboard surface may maintain the appearance of the substrate beneath the washable chalkboard surface, such as the color of a painted wall. In further embodiments, application of the semi-opaque washable chalkboard surface may result in maintaining a portion of the appearance of the substrate and a portion of the color of the semi-opaque washable chalkboard surface.

In a further embodiment, the special-effects surface includes a high-intensity treatment applied to a substrate, such as a poster board, paper, foam core board, a wall, paint, wood, plastic, concrete, glass, cloth, porous, nonporous, or other substrate, to provide a high-intensity surface. In some embodiments, upon applying a marking to the high-intensity surface, the high-intensity surface maintains the marking in close proximity to the surface to provide a brighter and/or bolder appearance as compared to a marking on a non-treated surface. For example, a high-intensity treatment may be applied to a paper substrate to generate a coated, high-intensity surface for receiving colored markings from non-permanent marking devices. The non-permanent marking device, such as a regular, broad line marker by Crayola® LLC of Easton, Pa., may produce markings on the high-intensity surface that are permanent, exhibiting a higher visible intensity than a colored marking on a non-treated paper surface. Accordingly, the high-intensity treatment on the high-intensity surface may maintain the colored marking in closer proximity to the surface of the treated paper (or similar surface) than a similar marking on a non-treated paper surface. As a result, in some embodiments, the high-intensity surface allows for a visual effect similar to that of a permanent marker to be displayed on the high-intensity surface without the risk of staining that is inherent when using a permanent marker. For example, a user handling a washable marking device may make permanent markings on a surface treated with the high-intensity treatment, without risking making a permanent marking on the user's own skin or other surrounding surfaces.

In some embodiments, the high-intensity treatment may be formulated to create a high-intensity surface that can receive and display markings from a plurality of marking devices when applied to a substrate. For example, the high-intensity surface may be formulated to receive markings from a nonpermanent marker, a permanent marker, a paintbrush, or any other marking device. The high-intensity treatment may also be formulated to create a high-intensity surface that can receive markings from specific corresponding marking devices. For example, the high-intensity treatment may be formulated to receive only markings from a nonpermanent marker or watercolor paints. In such embodiments, the high-intensity surface allows the corresponding markings to be maintained in closer proximity to the corresponding high-intensity surface than a similar marking on a non-treated surface.

Additionally, the marking on the high-intensity surface may be made by a plurality of marking devices. The marking devices may include a marking device configured to dispense an amount of ink from a reservoir onto a surface, a marking device configured to dispense an amount of water onto a surface, and a marking device configured to dispense an amount of paint onto a surface, among others. Some marking devices may include clear ink that is configured to be dispensed on the high-intensity surface, in some embodiments. In further embodiments, other marking devices may use water to create markings on a high-intensity surface formulated to receive water and display a high-intensity marking.

In embodiments, the high-intensity treatment may come in a variety of forms. Various embodiments of the high-intensity treatment may include a solution configured to coat the surface of the substrate; a powder configured to coat the surface of the substrate; a gel formulation configured to coat the surface of the substrate; a sheet containing a quantity of the high-intensity treatment configured to cover the surface of the substrate; an adhesive-backed sheet containing a quantity of the high-intensity treatment configured to cover the surface of the substrate; and an aerosol application configured to coat the surface of the substrate.

With reference now to the figures, special-effects surfaces are described in accordance with embodiments of the invention. Various embodiments are described with respect to the figures in which like elements are depicted with like reference numerals.

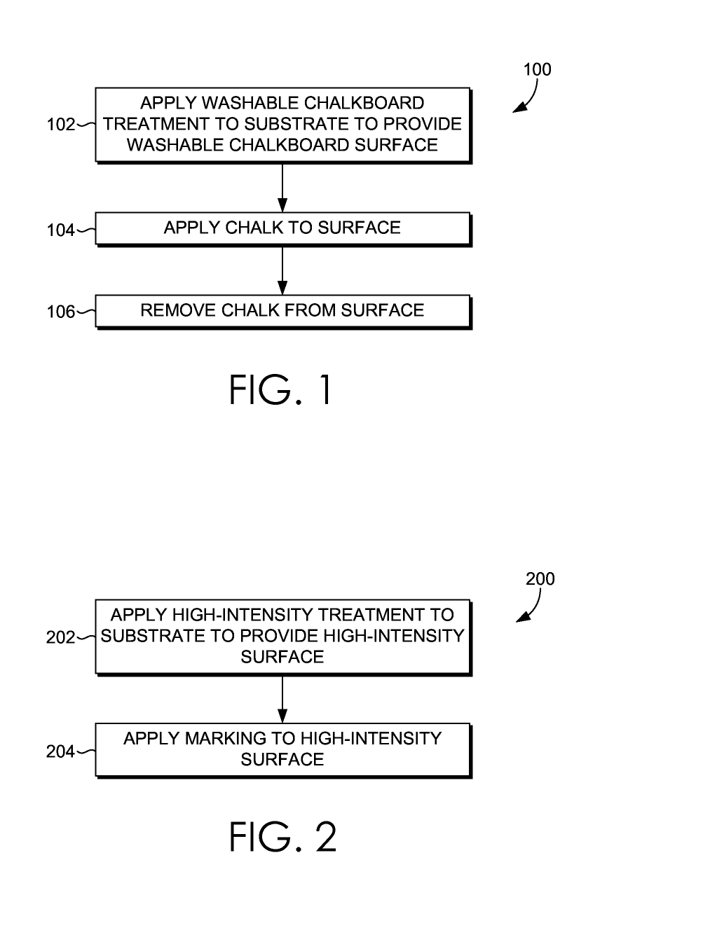

As depicted in the flow diagram of FIG. 1, embodiments of the invention include a method 100 for generating a washable chalkboard surface. In one embodiment, at block 102, a washable chalkboard treatment is applied to a substrate to provide a washable chalkboard surface. At block 104, a chalk marking is applied to the surface. Accordingly, at block 106, the chalk marking is removed from the surface, such as by washing the marking during removal.

With reference now to FIG. 2, another embodiment of the invention includes a method 200 for generating a high-intensity surface. In one embodiment, at block 202, a high-intensity treatment is applied to a substrate to provide a high-intensity surface. Further, at block 204, a marking is applied to the high-intensity surface. As described in embodiments above, the marking on the high-intensity surface may have a variety of visual effects and/or physical characteristics upon interaction between the surface treatment and the composition of the marking and/or marking solution.

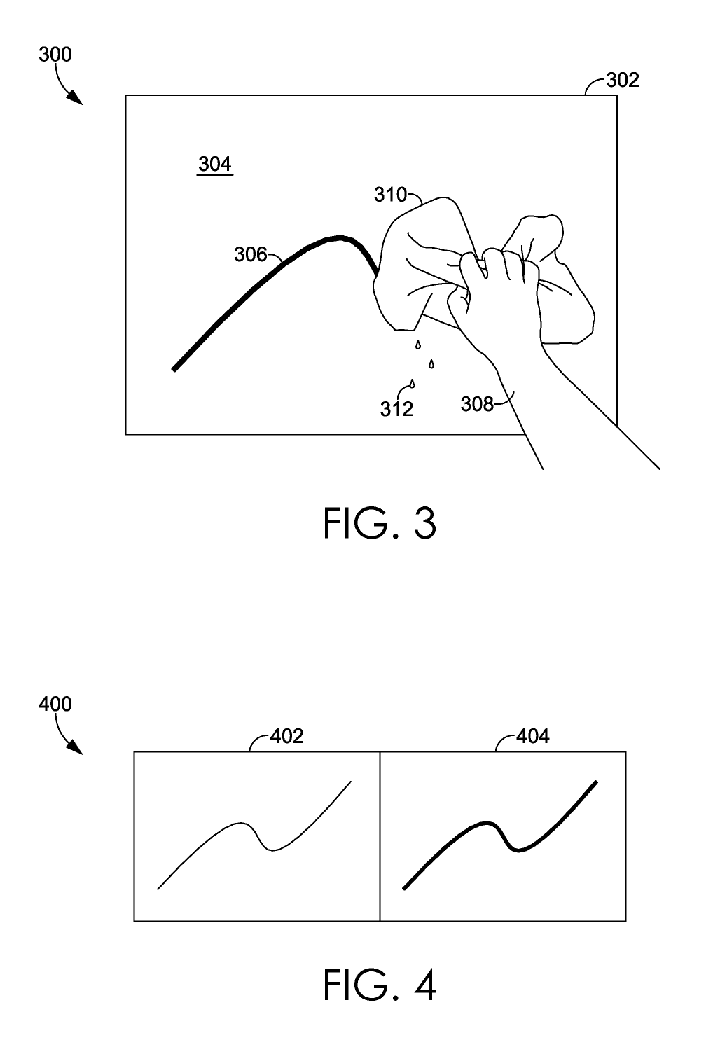

Turning now to FIG. 3, an exemplary substrate having received a washable chalkboard treatment and resulting in a washable chalkboard surface 300 is provided. The exemplary substrate is depicted at 302. The substrate having received a washable chalkboard treatment and resulting in a washable chalkboard surface 300 includes a chalkboard surface 304 for receiving markings. A marking 306 from a chalk dispensing device on the washable chalkboard surface 304 may be “washed off” by a user 308 with a removal device 310 and/or a removal agent 312, such as water.

With reference now to FIG. 4, an exemplary drawing environment 400 includes an untreated surface 402 and an exemplary high-intensity surface 404. The high-intensity surface 404, having received a high-intensity treatment on its surface, produces an enhanced marking as compared to a marking on the untreated surface 402. Accordingly, in embodiments of the invention, a high-intensity treatment may be used to generate a high-intensity surface that keeps a marking close to the surface of the substrate, thereby creating a bolder and brighter effect for viewing by a user (i.e., compared to the marking on the non-treated surface). In further embodiments, a non-permanent marking on a high-intensity surface, such as high-intensity surface 404, becomes a permanent marking on the surface of high-intensity surface 404.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A special-effects treatment kit, the kit comprising:
at least one of one or more special-effects treatments, wherein the at least one of the one or more special-effects treatments is one of a high-intensity treatment and a washable chalkboard treatment; and
at least one marking device configured to interact with the at least one of the one or more special-effects treatments.

2. The kit of claim 1, wherein the at least one of the one or more special-effects treatments is formulated to facilitate application to a substrate and upon application of the at least one of the one or more special-effects treatments to the substrate, a special-effects surface is created.

3. The kit of claim 2, wherein the substrate comprises one or more of:
paper;
poster board;
foam core board;
a wall;
paint;
wood;
plastic;
concrete;
glass; and
cloth.

4. The kit of claim 2, wherein the at least one marking device is configured to dispense an amount of ink from a reservoir onto the special-effects surface.

5. The kit of claim 2, wherein the at least one marking device is configured to dispense an amount of chalk residue onto the special-effects surface.

6. The kit of claim 2, wherein the at least one marking device is configured to dispense an amount of paint onto the special-effects surface.

7. The kit of claim 1, wherein the at least one of the one or more special-effects treatments comprises one or more of:
a solution configured to coat a surface of a substrate;
a powder configured to coat the surface of the substrate;
a gel formulation configured to coat the surface of the substrate;
a sheet containing at least a quantity of the at least one of the one or more a special-effects treatments configured to cover the surface of the substrate;
an adhesive-backed sheet containing at least a quantity of the at least one of the one or more a special-effects treatments configured to cover the surface of the substrate; and
an aerosol application configured to coat the surface of the substrate.

8. The kit of claim 1, wherein the kit further includes one or more of a removal device and an agent adapted to aid in the removal of markings.

9. A method of generating a washable chalkboard special-effects surface, the method comprising:
applying a washable chalkboard treatment to a surface of a substrate to provide a washable chalkboard surface,
wherein upon applying a chalk marking to the washable chalkboard surface, the chalk marking is removable at least in part from the washable chalkboard surface.

10. The method of claim 9, wherein the substrate comprises one or more of:
paper;
poster board;
foam core board;
a wall;
paint;
wood;
plastic;
concrete;
glass; and
cloth.

11. The method of claim 9, wherein the chalk marking comprises a marking from a chalk device configured to dispense an amount of chalk residue onto the washable chalkboard surface.

12. The method of claim 9, wherein the chalk marking may be removed from the washable chalkboard surface with at least one of water, a cleaning solution, a cleaning foam, a cloth, a chalk eraser, a cloth adapted to facilitate removal of markings, and a paper towel.

13. The method of claim 9, wherein the washable chalkboard treatment comprises one or more of:
a solution configured to coat the surface of the substrate;
a powder configured to coat the surface of the substrate;
a gel formulation configured to coat the surface of the substrate;
a sheet containing at least a quantity of the washable chalkboard treatment configured to cover the surface of the substrate;
an adhesive-backed sheet containing at least a quantity of the washable chalkboard treatment configured to cover the surface of the substrate; and
an aerosol application configured to coat the surface of the substrate.

14. The method of claim 9, wherein the washable chalkboard surface is one of a clear washable chalkboard surface, a semi-opaque washable chalkboard surface, and an opaque washable chalkboard surface.

15. A method of generating a high-intensity special-effects surface, the method comprising:
applying a high-intensity treatment to a substrate to provide a high-intensity surface,
wherein upon applying a marking to the high-intensity surface, the marking is held in closer proximity to the high-intensity surface than a marking applied to a surface without the high-intensity treatment.

16. The method of claim 15, wherein the substrate comprises one or more of:
paper;
poster board;
foam core board;
a wall;
paint;
wood;
plastic;
concrete;
glass; and
cloth.

17. The method of claim 15, wherein the high-intensity treatment is formulated to receive markings from a corresponding marking device.

18. The method of claim 15, wherein the marking comprises a marking from one or more of a marking device configured to dispense an amount of ink from a reservoir onto a surface, a marking device configured to dispense an amount of water onto a surface, and a marking device configured to dispense an amount of paint onto a surface.

19. The method of claim 15, wherein the marking device dispenses an amount of non-permanent ink, and further wherein the colored marking is held in closer proximity to the enhanced substrate such that the colored marking is permanent on the enhanced substrate.

20. The method of claim 15, wherein the high-intensity treatment comprises one or more of:
a solution configured to coat the surface of the substrate;
a powder configured to coat the surface of the substrate;
a gel formulation configured to coat the surface of the substrate;
a sheet containing at least a quantity of the high-intensity treatment configured to cover the surface of the substrate;
an adhesive-backed sheet containing at least a quantity of the high-intensity treatment configured to cover the surface of the substrate; and
an aerosol application configured to coat the surface of the substrate.
